(19) United States
(12) Patent Application Publication
(10) Pub. No.: US 2011/0217686 A1
(43) Pub. Date: Sep. 8, 2011

(54) TECHNIQUES FOR ENABLING ANONYMOUS INTERACTIVE SURVEYS AND POLLING

(75) Inventors: Robert Louis Bernatz, Newport Beach, CA (US); Don Kobayashi, Newport Beach, CA (US)

(73) Assignee: VOXopolis Inc., Newport Beach, CA (US)

(21) Appl. No.: 13/034,428

(22) Filed: Feb. 24, 2011

Related U.S. Application Data
(60) Provisional application No. 61/311,134, filed on Mar. 5, 2010.

(51) Int. Cl. G09B 5/00

(52) U.S. Cl. 434/350

(57) ABSTRACT

Techniques for enabling interactive (e.g., two-way) electronic communication between survey/polling administrators and anonymous survey/polling respondents. In one set of embodiments, a user (e.g., respondent) can access and provide responses to a particular survey or poll. The responses can then be routed to an administrator or manager of the survey/poll in a manner that keeps the identity of the respondent hidden. Upon receiving the responses, the administrator can interactively communicate with the respondent while maintaining the respondent's anonymity.

### CROSS-REFERENCES TO RELATED APPLICATIONS

The present application claims the benefit and priority under 35 U.S.C. 119(e) of U.S. Provisional Application No. 61/311,134, filed Mar. 5, 2010 and entitled “AN ELECTRONIC MECHANISM TO ENABLE ANONYMOUS INTERACTIVE SURVEYS AND POLLING,” the entire contents of which are incorporated herein by reference for all purposes.

In addition, the present application is related to U.S. application Ser. No. 12/828,037, filed Jun. 30, 2010 and entitled “TECHNIQUES FOR ENABLING ANONYMOUS INTERACTIVE COMMUNICATION,” the entire contents of which are incorporated herein by reference for all purposes.

### BACKGROUND

The present disclosure relates in general to anonymous communication, and in particular to techniques for enabling anonymous interactive communication in the context of electronic surveys and polls.

Anonymous communication can be a powerful tool for helping entities (e.g., individuals, organizations, communities, etc.) garner truthful information, objective facts, and important data about sensitive subjects. In many cases, such information is not openly shared due to fear of retribution or other concerns such as damaging a close personal/professional relationship or disrupting a team/community. By hiding the identity of the information sender from the information recipient, anonymous communication can facilitate information exchange in a manner that is relatively free of recourse or retribution, thereby enabling the participants to reach a new level of efficiency, effectiveness, and knowledge.

One issue with existing electronic tools for anonymous communication is that such tools generally support communication in only one direction—from the anonymous sender to the known recipient. For example, in a typical electronic survey or poll, parties (i.e., respondents) can submit responses anonymously to an administrator or manager of the survey/poll. However, the administrator cannot communicate back to a particular respondent in a manner that keeps the respondent's identity anonymous. Thus, with existing survey/polling mechanisms, administrators are unable to interact with anonymous respondents in a two-way manner to seek clarification or additional information regarding, e.g., the presented questions or the submitted responses.

### BRIEF SUMMARY

Embodiments of the present invention provide techniques for enabling interactive (e.g., two-way) electronic communication between survey/polling administrators and anonymous survey/polling respondents. In one set of embodiments, a user (e.g., respondent) can access and provide responses to a particular survey or poll. The responses can then be routed to an administrator or manager of the survey/poll in a manner that keeps the identity of the respondent hidden. Upon receiving the responses, the administrator can interactively communicate with the respondent while maintaining the respondent's anonymity.

The techniques described herein can provide a number of advantages over prior art survey/polling mechanisms. For example, as discussed above, certain embodiments can enable a survey/polling administrator and an anonymous survey/polling respondent to conduct a two-way dialogue, rather than limiting communication to a single direction. This dialogue can continue indefinitely until one of the participants breaks off communication. Since the administrator can seek clarification or additional information from the respondent without compromising the respondent's anonymity, the effectiveness of the survey/poll can be significantly enhanced.

According to one embodiment of the present invention, a method is provided that comprises receiving, by a computer system from a respondent, one or more responses to a survey or poll, and communicating, by the computer system, the one or more responses to an administrator of the survey or poll, wherein the identity of the respondent is kept anonymous. The method further comprises enabling, by the computer system, the administrator to interactively communicate with the respondent regarding the one or more responses while keeping the identity of the respondent anonymous.

In one embodiment, the method further comprises, prior to receiving the one or more responses, generating a sign-in user interface requesting a non-anonymous identifier from the respondent; receiving from the respondent the non-anonymous identifier; and generating account information for the respondent, the account information including the non-anonymous identifier and an anonymous identifier.

In one embodiment, the method further comprises, upon receiving the one or more responses, associating the one or more responses with the account information generated for the respondent.

In one embodiment, the non-anonymous identifier is an e-mail address. In a further embodiment, the anonymous identifier is a randomly-generated string.

In one embodiment, the method further comprises, prior to receiving the one or more responses, generating a sign-in user interface requesting a non-anonymous identifier and authentication information from the respondent; receiving from the respondent the non-anonymous identifier and the authentication information; and authenticating the respondent based on the non-anonymous identifier and the authentication information, the authenticating including accessing account information previously generated for the respondent.

In one embodiment, the method further comprises, upon receiving the one or more responses, associating the one or more responses with the account information previously generated for the respondent.

In one embodiment, the non-anonymous identifier is an e-mail address. In a further embodiment, the authentication information is an account password.

In one embodiment, communicating the one or more responses to the administrator comprises transmitting an e-mail including the one or more responses to the administrator.

In one embodiment, communicating the one or more responses to the administrator comprises generating a user interface for presenting the one or more responses to the administrator, the one more responses being identified in the user interface as being sent from an anonymous identifier.

In one embodiment, enabling the administrator to interactively communicate with the respondent regarding the one or more responses while keeping the identity of the respondent anonymous comprises receiving a message from the administrator addressed to the anonymous identifier; communicating the message to the respondent; and enabling the respondent to respond to the message.

In one embodiment, communicating the message to the respondent comprises determining, based on the anonymous identifier, an e-mail address of the respondent, and transmitting an e-mail to the e-mail address notifying the respondent that the message has been sent.

In one embodiment, the one or more responses include qualitative responses. In an alternative embodiment, the one or more responses include quantitative responses.

According to another embodiment of the present invention, a computer-readable storage medium having stored thereon program code executable by a processor is provided. The program code comprises code that causes the processor to receive one or more responses to a survey or poll; code that causes the processor to communicate the one or more responses to an administrator of the survey or poll, wherein the identity of the respondent is kept anonymous; and code that causes the processor to enable the administrator to interactively communicate with the respondent regarding the one or more responses while keeping the identity of the respondent anonymous.

According to yet another embodiment of the present invention, a computer system is provided. The computer system includes a processor configured to receive, from a respondent, one or more responses to a survey or poll; communicate the one or more responses to an administrator of the survey or poll, wherein the identity of the respondent is kept anonymous; and enable the administrator to interactively communicate with the respondent regarding the one or more responses while keeping the identity of the respondent anonymous.

A further understanding of the nature and advantages of the embodiments disclosed herein can be realized by reference to the remaining portions of the specification and the attached drawings.

### BRIEF DESCRIPTION OF THE DRAWINGS

FIG. 1 is a simplified block diagram illustrating a system environment in accordance with an embodiment of the present invention.

FIG. 2 is a simplified block diagram illustrating a computer system in accordance with an embodiment of the present invention.

FIG. 3 is a flow diagram illustrating a process for creating a new survey or poll in accordance with an embodiment of the present invention.

FIGS. 4A and 4B are flow diagrams illustrating a process for enabling interactive communication between a survey/polling administrator and an anonymous survey/polling respondent in accordance with an embodiment of the present invention.

FIGS. 5-8 are example user interfaces for creating a new survey or poll in accordance with an embodiment of the present invention.

FIGS. 9 and 10 are example user interfaces for authenticating or registering a survey/polling respondent in accordance with an embodiment of the present invention.

FIGS. 11 and 12 are example user interfaces to entering survey/poll responses in accordance with an embodiment of the present invention.

FIG. 13 is an example user interface for managing received messages in accordance with an embodiment of the present invention.

FIG. 14 is an example user interface for viewing a particular message in accordance with an embodiment of the present invention.

FIG. 15 is an example user interface for composing a reply to a message in accordance with an embodiment of the present invention.

### DETAILED DESCRIPTION

In the following description, for the purposes of explanation, numerous details are set forth in order to provide an understanding of embodiments of the present invention. It will be apparent, however, to one of ordinary skill in the art that certain embodiments can be practiced without some of these details.

Embodiments of the present invention provide techniques for enabling interactive (e.g., two-way) electronic communication between survey/polling administrators and anonymous survey/polling respondents. In one set of embodiments, a user (e.g., respondent) can access and provide responses to a particular survey or poll. The responses can then be routed to an administrator or manager of the survey/poll in a manner that keeps the identity of the respondent hidden. Upon receiving the responses, the administrator can interactively communicate with the respondent while maintaining the respondent's anonymity.

The techniques described herein can provide a number of advantages over prior art survey/polling mechanisms. For example, as discussed above, certain embodiments can enable a survey/polling administrator and an anonymous survey/polling respondent to conduct a two-way dialogue, rather than limiting communication to a single direction. This dialogue can continue indefinitely until one of the participants breaks off communication. Since the administrator can seek clarification or additional information from the respondent without compromising the respondent's anonymity, the effectiveness of the survey/poll can be significantly enhanced.

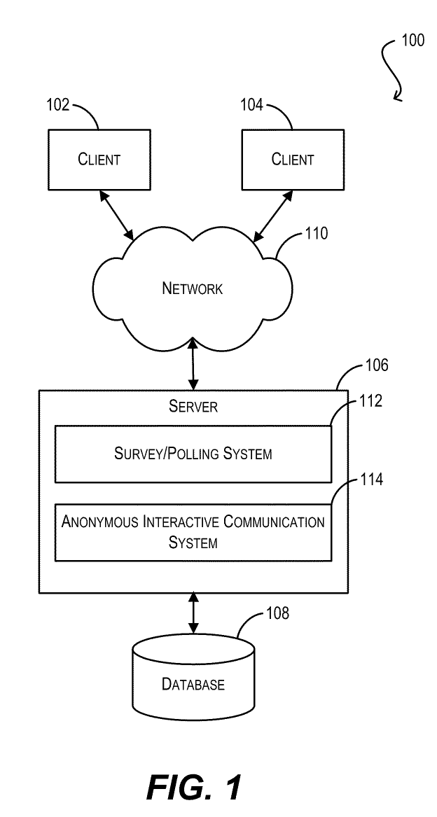

FIG. 1 is a simplified block diagram of a system environment 100 in accordance with an embodiment of the present invention. As shown, system environment 100 can include clients 102, 104, a server 106, and a database 108 communicatively coupled via a network 110. Although FIG. 1 depicts two clients, one server, and one database, any number of clients, servers, and databases can be supported.

Clients 102, 104 can be configured to execute a client-side program (e.g., a Web browser, propriety client application, etc.) for interacting with server 106. Clients 102, 104 can be general purpose computers, such as desktop or laptop computers running a version of Microsoft Windows, Apple OS X, or another consumer operating system. Clients 102, 104 can also be any other type of electronic device (e.g., a smart phone, PDA, tablet, netbook, or the like) that is capable of communicating over a network and interacting with server 106.

Server 106 can be configured to run one or more server-side applications, such as a survey/polling system 112 and an anonymous interactive communication system 114. In certain embodiments, server 106 can be part of a scalable server cloud. Like clients 102, 104, server 106 can be a general purpose computer that runs any of a variety of consumer operating systems. Server 106 can also be a specialized server computer, such as a rack-mounted server, that is configured to run a server-oriented operating system (e.g., Solaris, FreeBSD, Linux, etc.).

Survey/polling system 112 can be a software and/or hardware based component of server 106 and can provide various services for managing and publishing electronic surveys and/or polls. For example, survey/polling system 112 can enable an administrator to create a new survey or poll, can enable users (e.g., respondents) to access and submit responses to a particular survey or poll, and can store the survey/poll responses for later retrieval by the administrator. In one set of embodiments, survey/polling system 112 can be a commercially available survey/polling application or service, such as SurveyMonkey.com, Zoomerang.com, and the like.

Anonymous interactive communication system 114 can be a software and/or hardware based component of server 106 and can provide various services for facilitating anonymous interactive communication among a group of users. In one set of embodiments, anonymous interactive communication system 114 can maintain account information for a group of registered users, where the account information includes, inter alia, an anonymous identifier, a non-anonymous identifier, and a password for each user. Based on this account information, anonymous interactive communication system 114 can enable two or more users to communicate in an interactive (e.g., two-way) manner, while maintaining the anonymity of one user. Additional disclosure pertaining to such a system can be found in U.S. application Ser. No. 12/828,037, filed Jun. 30, 2010 and entitled “TECHNIQUES FOR ENABLING ANONYMOUS INTERACTIVE COMMUNICATION,” the entire contents of which are incorporated herein by reference for all purposes. In alternative embodiments, system 114 can be any type of existing or future system or service that enables anonymous, two-way communication between two or more parties.

In certain embodiments, survey/polling system 112 can interoperate with anonymous interactive communication system 114 to enable interactive communication between a survey/polling administrator and an anonymous survey/polling respondent. According to one embodiment, a user (e.g., respondent) can access survey/polling system 112 (e.g., via client 104) to participate in a survey or poll created by an administrator. In response, survey/polling system 112 can request the respondent to register or login to anonymous interactive communication system 114. This registration/login process can include receiving an non-anonymous identifier (e.g., email address) from the respondent and determining or generating a corresponding anonymous identifier.

Once logged in to system 114, the respondent can enter, via survey/polling system 112, responses to the questions presented in the survey or poll. These responses can then be forwarded to anonymous interactive communication system 114, where they can be formatted and stored as a message for later retrieval by the administrator. In a particular embodiment, the message only identifies the respondent by his/her anonymous identifier; the message does not include the respondent's non-anonymous identifier or any other identifying information, thereby preserving his/her anonymity.

The administrator can then login to anonymous interactive communication system 114 (e.g., via client 102) and access a message management interface for managing the messages he/she has received or sent. Through this interface, the administrator can view the survey/poll responses received from the respondent. The administrator can further access a message composition interface for composing a reply message addressed to the anonymous identifier of the respondent. System 114 can then automatically route and store the reply message so that it is accessible to the respondent. In this manner, the administrator and the respondent can communicate back and forth via system 114 while keeping the respondent's identity hidden. Additional details regarding the processing performed by systems 112 and 114 are described below.

In one set of embodiments, survey/polling system 112 and anonymous interactive communication system 114 can each be implemented as a web-based application. In these embodiments, systems 112 and 114 can include or interoperate with a web server module, such as Apache, and clients 102, 104 can communicate with systems 112 and 114 via HyperText Transfer Protocol (HTTP).

In another set of embodiments, survey/polling system 112 and anonymous interactive communication system 114 can each be implemented as a server application for mobile devices (e.g., smartphones, tablets, etc.). In these embodiments, clients 102, 104 can access systems 112 and 114 via either a standard or application-specific communications protocol.

Data managed by survey/polling system 112 and anonymous interactive communication system 114 (e.g., survey/poll questions and responses, user account information, user-generated messages, etc.) can be stored in one or more data stores such as database 108. In FIG. 1, database 108 is shown as being remote from server 106. For example, database 108 can reside in a storage-area network (SAN) familiar to those skilled in the art. Alternatively, database 108 can reside on a storage medium local to (or resident in) server 106. Database 108 can be implemented using any of a number of commercially available database systems, including those available from Oracle, Microsoft, Sybase, and IBM. In a particular embodiment, database 108 can be a relational database that is adapted to store, update, and retrieve data in response to SQL-formatted commands.

Network 110 can be any type of data communications network such as a local area network (LAN), a wide-area network (WAN), a virtual network (e.g., VPN), or the Internet. In certain embodiments, the various components of system architecture 100 can communicate over different types of networks. For example, in one embodiment clients 102, 104 can communicate with server 106 via the Internet, and server 106 can communicate with database 108 via a secure, local area network.

It should be appreciated that system environment 100 of FIG. 1 is illustrative and not intended to limit embodiments of the present invention. For example, although survey/polling system 112 and anonymous interactive communication system 114 are shown as being run on a single server 106, in certain embodiments these systems can be distributed over multiple servers. Further, the various entities depicted in FIG. 1 can have other capabilities or include other components that are not specifically described. One of ordinary skill in the art will recognize other variations, modifications, and alternatives.

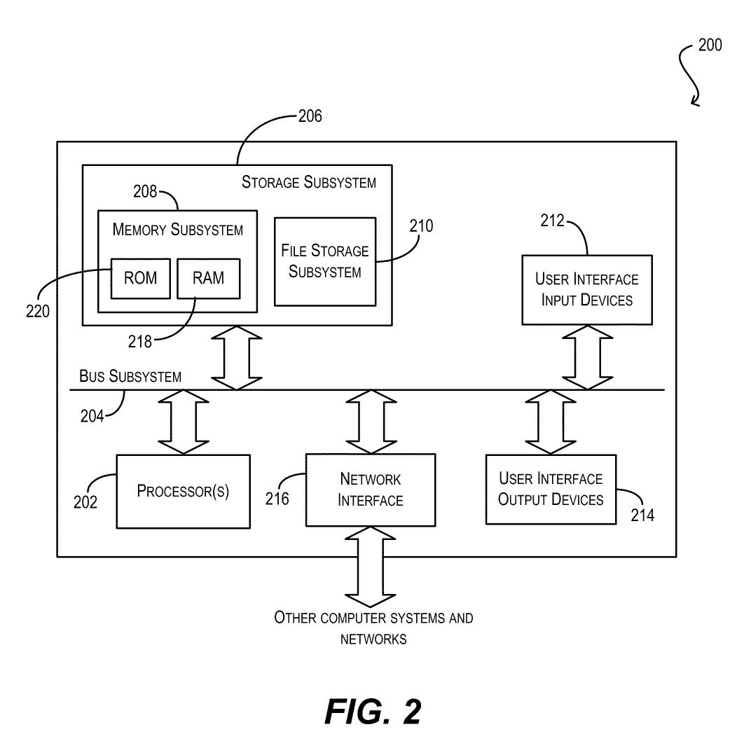

FIG. 2 is a simplified block diagram of a computer system 200 in accordance with an embodiment of the present invention. Computer system 200 can be used to implement any of the clients or servers 102, 104, 106 illustrated in FIG. 1. As shown in FIG. 2, computer system 200 can include one or more processors 202 that communicate with a number of peripheral devices via a bus subsystem 204. These peripheral devices can include a storage subsystem 206 (comprising a memory subsystem 208 and a file storage subsystem 210), user interface input devices 212, user interface output devices 214, and a network interface subsystem 216.

Bus subsystem 204 can provide a mechanism for letting the various components and subsystems of computer system 200 communicate with each other as intended. Although bus subsystem 204 is shown schematically as a single bus, alternative embodiments of the bus subsystem can utilize multiple busses.

Network interface subsystem 216 can serve as an interface for communicating data between computer system 200 and other computer systems or networks (e.g., network 110 of FIG. 1). Embodiments of network interface subsystem 216 can include an Ethernet card, a modem (telephone, satellite, cable, ISDN, etc.), digital subscriber line (DSL) units, and the like.

User interface input devices 212 can include a keyboard, pointing devices (e.g., mouse, trackball, touchpad, etc.), a scanner, a barcode scanner, a touch-screen incorporated into a display, audio input devices (e.g., voice recognition systems, microphones, etc.) and other types of input devices. In general, use of the term “input device” is intended to include all possible types of devices and mechanisms for inputting information into computer system 200.

User interface output devices 214 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 200.

Storage subsystem 206 can include a memory subsystem 208 and a file/disk storage subsystem 210. Subsystems 208 and 210 represent computer-readable storage media that can store program code and/or data that provide the functionality of the present invention.

Memory subsystem 208 can include a number of memories including a main random access memory (RAM) 218 for storage of instructions and data during program execution and a read-only memory (ROM) 220 in which fixed instructions are stored. File storage subsystem 210 can provide persistent (i.e., non-volatile) storage for program and data files, and can include a magnetic or solid-state hard disk drive, a floppy disk drive along with associated removable media, an optical drive along with associated removable media (e.g., CD-ROM, DVD, Blu-Ray, etc.), a removable flash memory-based drive or card, and/or other types of storage media known in the art.

It is should be appreciated that computer system 200 is illustrative and not intended to limit embodiments of the present invention. Many other configurations having more or fewer components than system 200 are possible.

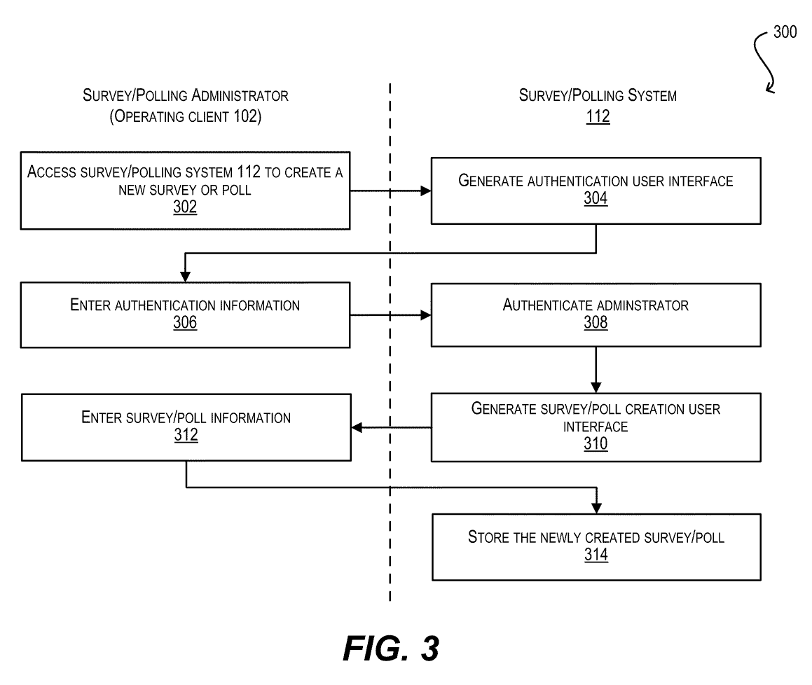

As discussed above, survey/polling system 112 and anonymous interactive communication system 114 of FIG. 1 enable the creation/management of surveys/polls and facilitate interactive communication between survey/polling administrators and anonymous survey/polling respondents. FIG. 3 is a flow diagram illustrating a process 300 for enabling a survey/polling administrator to create a new survey or poll via survey/polling system 112 according to an embodiment of the present invention. In one set of embodiments, the administrator can access survey/polling system 112 via client 102 of FIG. 1.

At block 302, the administrator can electronically access survey/polling system 112 with the intent of creating a new survey or poll. For example, if survey/polling system 112 is implemented as a web-based application, the administrator can access system 112 by opening a web browser and navigating to the URL assigned to system 112. If survey/polling system 112 is implemented as a server application for mobile devices, the administrator can access system 112 by launching a client application on his/her mobile device.

At block 304, survey/polling system 112 can generate a user interface designed to authenticate users attempting to access management functions (e.g., new survey/poll creation) of the system. In response, the administrator can provide his or her appropriate authentication credentials, such as a password, a PIN number, or the like (block 306). At block 308, system 112 can authenticate the administrator based on the provided credentials.

Once the administrator is authenticated, survey/polling system 112 can generate one or more user interfaces for creating a new survey or poll (block 310). In one set of embodiments, these user interfaces can be organized according to a “wizard” paradigm, where each user interface allows the administrator to define one or more aspects of the survey/poll.

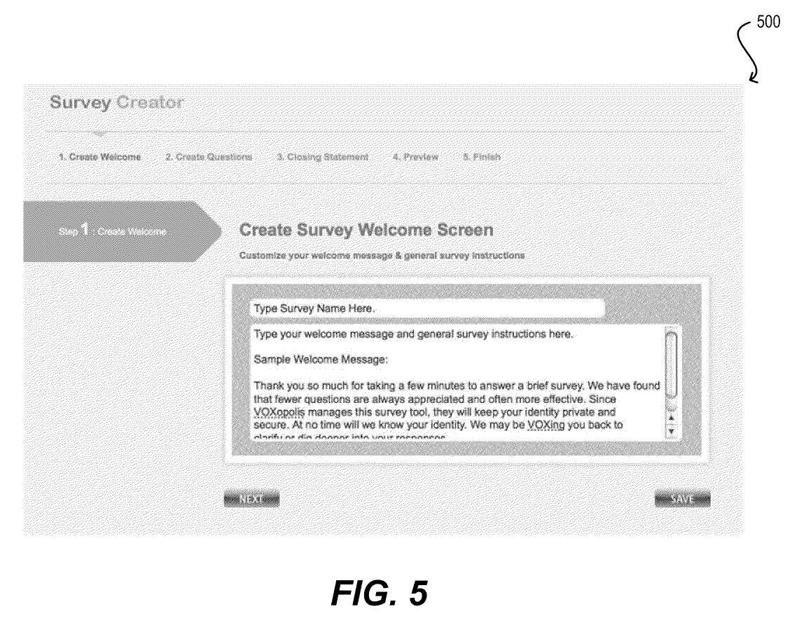

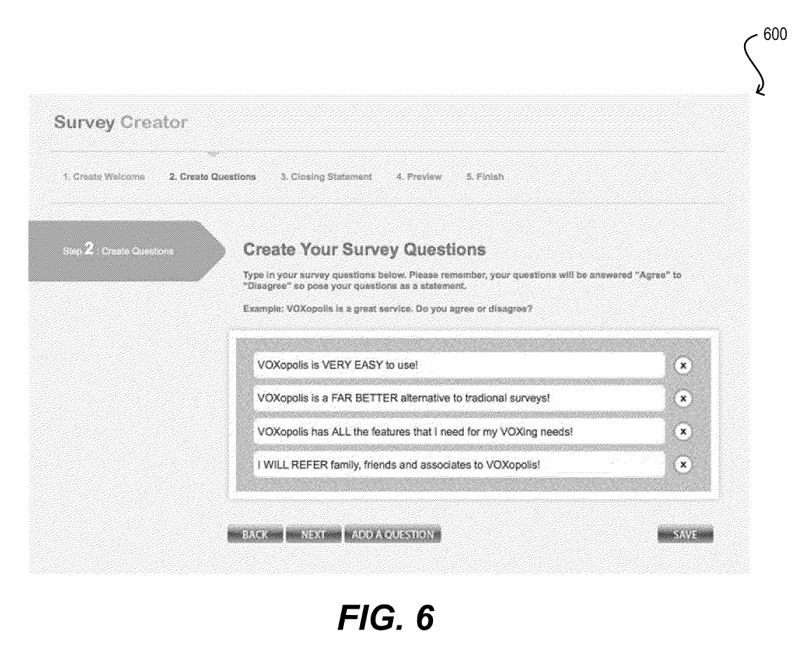

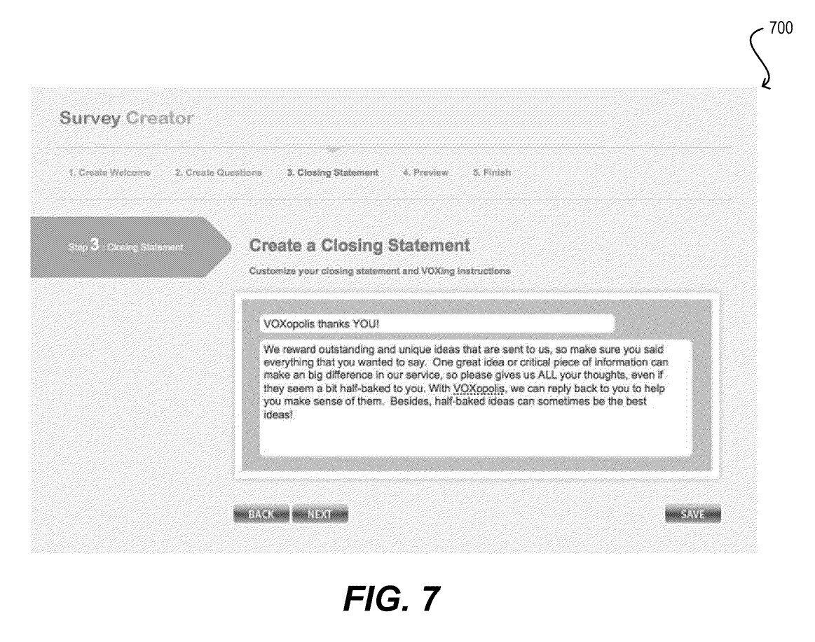

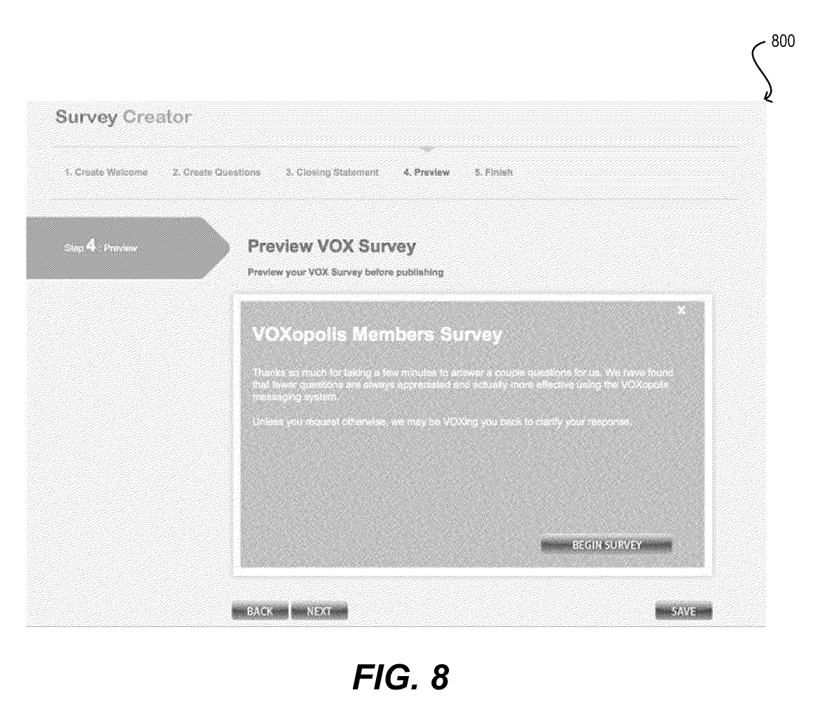

FIGS. 5-9 illustrate a series of exemplary survey/poll creation user interfaces 500-900. In user interface 500, the administrator can create a welcome statement to be presented to respondents upon accessing the survey/poll. In user interface 600, the administrator can create one or more survey/poll questions, where the questions are designed to elicit qualitative or quantitative responses. For certain types of questions, the administrator can define a number of answer choices that can be selected by a respondent. For other types of questions, the administrator can allow the respondent to enter a free-text response. In user interface 700, the administrator can create a closing statement to be presented to respondents at the end of the survey/poll. In a particular embodiment, the closing statement can indicate that the survey/polling administrator may contact the respondents for clarification on the submitted responses. And in user interface 800, the administrator can preview the created survey/poll.

Returning to FIG. 3, once the administrator has entered the survey/poll information (block 312), survey/polling system 112 can save the newly created survey/poll (block 314). As discussed in further detail below, survey/polling system 112 can subsequently enable respondents to access the survey/poll and anonymously submit responses.

It should be appreciated that process 300 is illustrative and that variations and modifications are possible. For example, steps described as sequential may be executed in parallel, order of steps may be varied, and steps may be modified, combined, added, or omitted. One of ordinary skill in the art would recognize other variations, modifications, and alternatives.

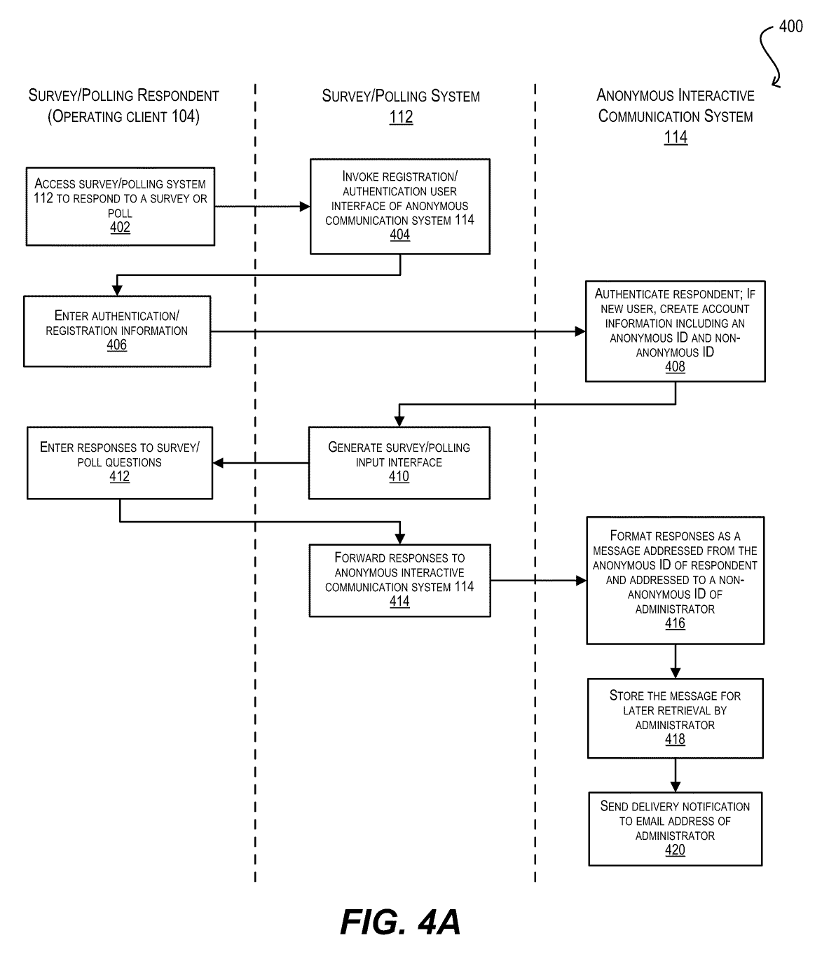

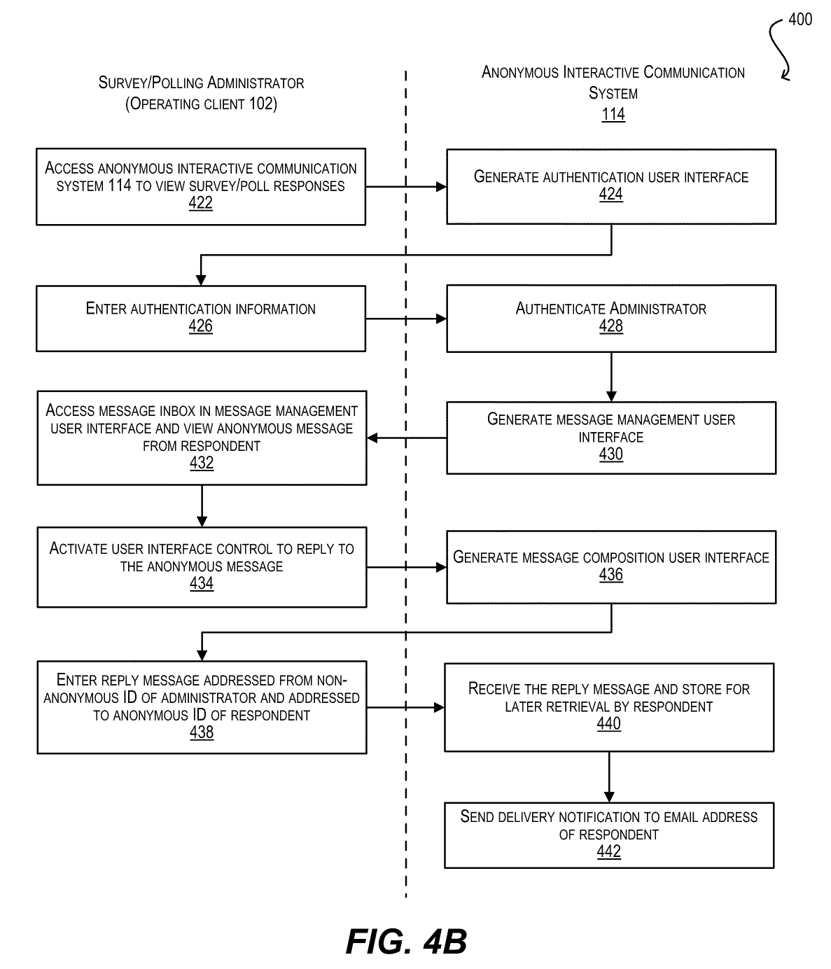

FIGS. 4A and 4B are flow diagrams illustrating a process 400 for enabling interactive communication between the survey/polling administrator of FIG. 3 and an anonymous survey/polling respondent according to an embodiment of the present invention. In particular, FIG. 4A illustrates interactions between a survey/polling respondent, survey/polling system 112, and anonymous interactive communication system 114 that enable the respondent to anonymously submit responses to the survey/poll created in FIG. 3. In one set of embodiments, the respondent can access systems 112 and 114 via client 104 of FIG. 1. FIG. 4B illustrates interactions between the administrator and anonymous interactive communication system 114 that enable the administrator to view the responses and send a reply message to the respondent while maintaining the respondent's anonymity.

The various steps of process 400 can be implemented in software, hardware, or a combination thereof. As software, process 400 can be encoded as program code stored on a non-transitory, machine-readable storage medium.

At block 402, the respondent can electronically access survey/polling system 112 with the intent of anonymously responding to the survey/poll created by the administrator in FIG. 3. For example, if survey/polling system 112 is implemented as a web-based application, the respondent can access system 112 by opening an web browser and navigating to the URL assigned to system 112. If survey/polling system 112 is implemented as a server application for mobile devices, respondent can access system 112 by launching a client application on his/her mobile device.

At block 404, survey/polling system 112 can request that the respondent register or login to anonymous interactive communication system 114, and can invoke an appropriate registration/authentication user interface of system 114. In various embodiments, this enables anonymous interactive communication system 114 to associate the respondent's survey/poll responses with an account maintained by system 114, and thus allows the administrator and respondent to interactively communicate via system 114 at a later stage (described in further detail below).

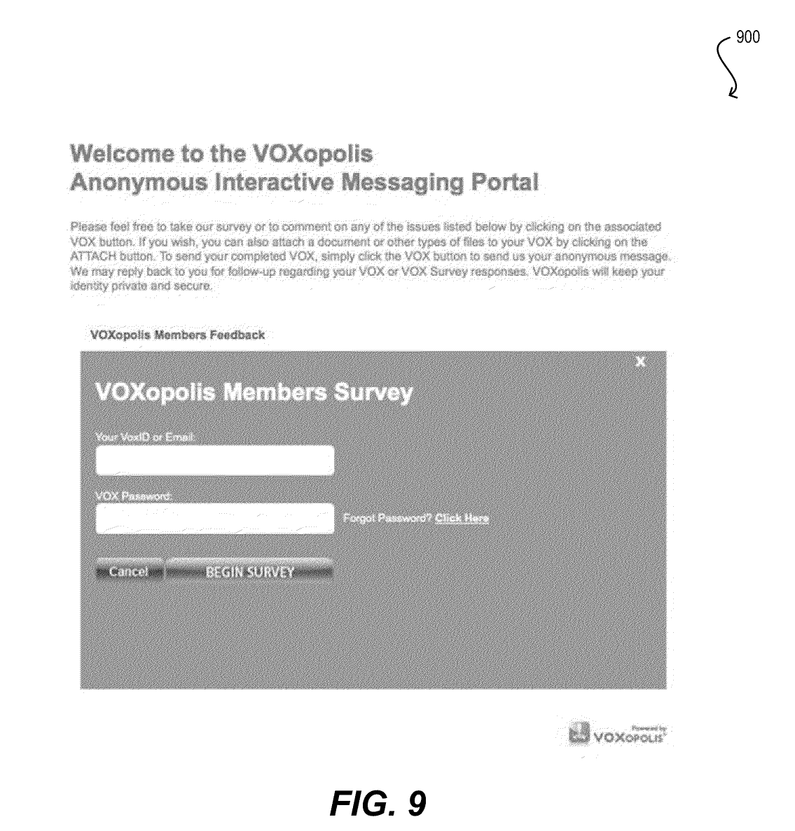

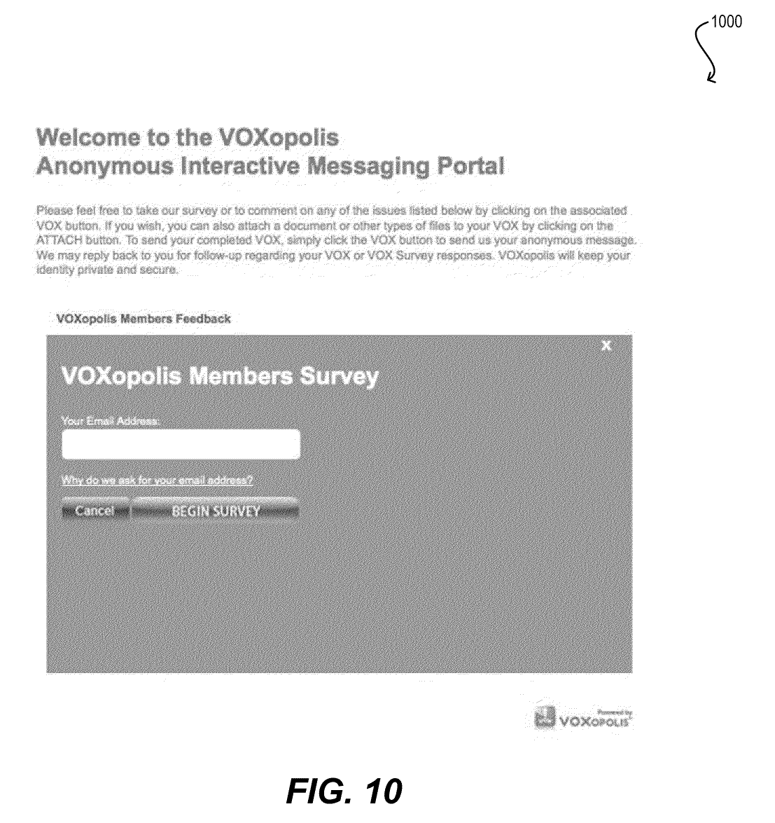

If the respondent is already registered with anonymous interactive communication system 114, system 114 can prompt the respondent to enter a non-anonymous identifier (e.g., email address) and a password that is stored by the system (block 406). The system can then authenticate the user based on the entered credentials (block 408). FIG. 9 illustrates an example authentication interface 900 that includes fields for a “VoxID” or email address (i.e., non-anonymous identifier) and a password.

If the respondent has not previously registered with anonymous interactive communication system 114, system 114 can prompt the respondent to enter registration information such as name, email address, password, and the like (block 406). System 114 can then create a new account for the respondent based on the entered registration information and store anonymous and non-anonymous identifiers for the user (block 408). As discussed below, the anonymous identifier can be used as an alias for the respondent when sending the respondent's survey/poll responses to the administrator. thereby preserving the respondent's anonymity.

In one set of embodiments, anonymous interactive communication system 114 can automatically generate the anonymous and non-anonymous identifiers for the respondent upon registration. For example, system 114 can assign a random or pseudo-random sequence of alphanumeric characters as the respondent's anonymous identifier, and assign the respondent's name or email address as the respondent's non-anonymous identifier. In other embodiments, the respondent can select his/her own anonymous and/or non-anonymous identifiers as part of the registration process.

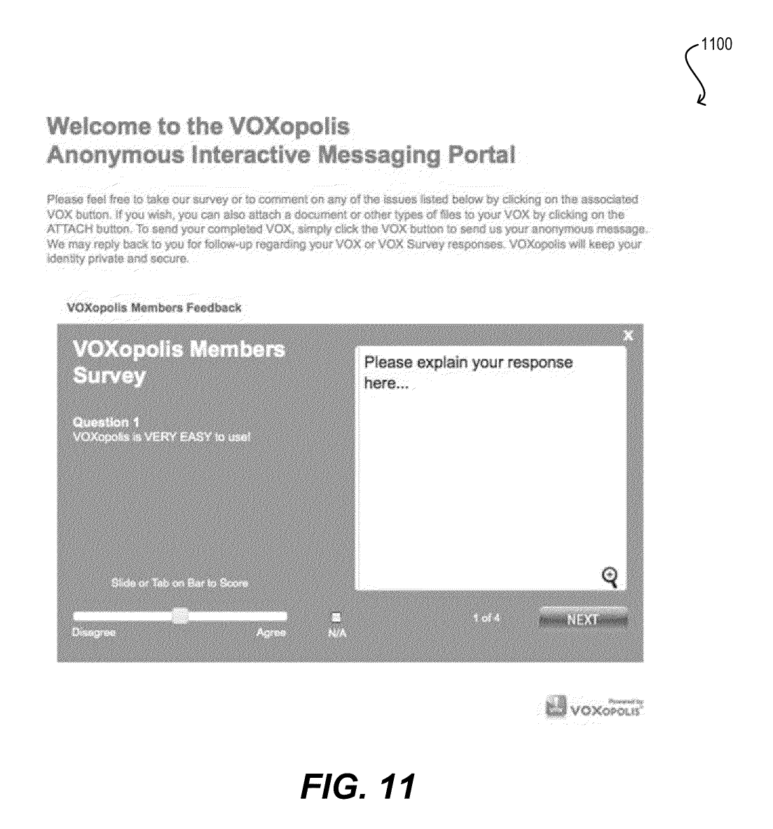

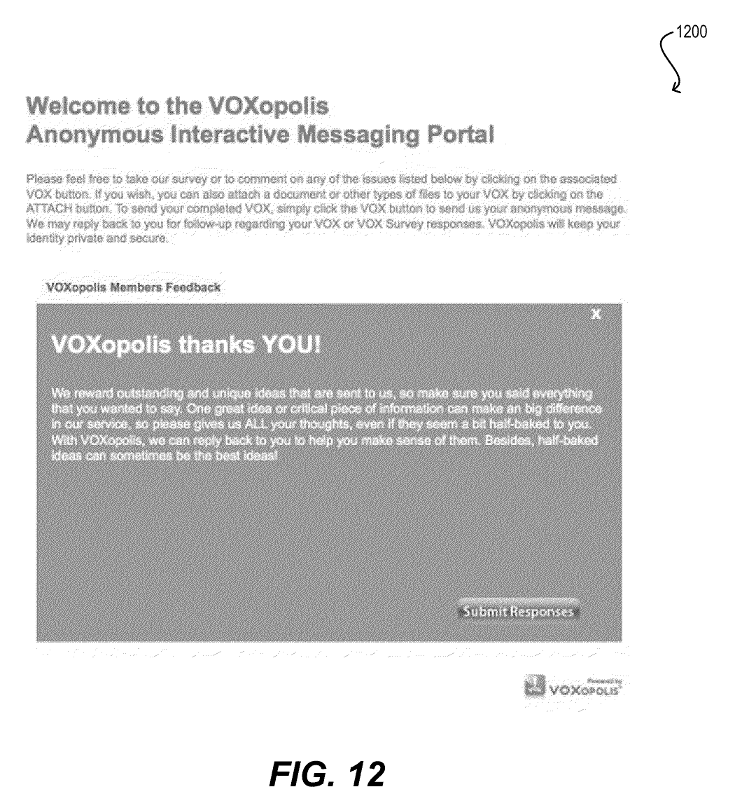

Once the respondent has been authenticated/registered with anonymous interactive communication system 114, survey/polling system 112 can generate a survey/polling input interface for presenting the questions included in the survey/poll to the respondent (block 410). FIGS. 11 and 12 illustrate example input user interfaces 1100 and 1200. The respondent can then submit responses to the questions via the input interface (block 412).

Once the respondent has submitted his/her responses, survey/polling system 112 can forward the responses to anonymous interactive communication system 114 (block 414). Although not shown, survey/polling system 112 can also store the responses for later retrieval within system 112, and/or transmit a copy of the responses directly to the administrator via email (or some other notification mechanism).

At block 416, anonymous interactive communication system 114 can receive the responses from survey/polling system 112 and format the responses for delivery to the administrator. In particular, system 114 can format the responses as a message addressed from the anonymous identifier of the respondent (as determined at block 408) and addressed to a non-anonymous identifier of the administrator. System 114 can then store the message for later retrieval by the administrator (block 418). Since the stored message does not include any information that would reveal the respondent's identity to the administrator, the anonymity of the respondent can be maintained.

In certain embodiments, anonymous interactive communication system 114 can send a delivery notification to an email address of the administrator to notify the administrator that a new anonymous message has been received (block 420). In a particular embodiment, the notification email can include a hypertext link or other mechanism to navigate directly to system 114 and view the message. Alternatively, system 114 can send a delivery notification to the administrator via other means (e.g., SMS text message, automated voice call, instant messenger message, etc.).

Turning now to FIG. 4B, the administrator can access anonymous interactive communication system 114 to view the survey/poll responses submitted by the respondent (block 422). Like blocks 406 and 408 of FIG. 4A, the administrator can provide authentication credentials for logging in to system 114 (blocks 424-428). Once the administrator is authenticated, system 114 can generate a message management user interface for the administrator (block 430). In one set of embodiments, this message management user interface can be similar to a typical email program user interface, with a message inbox, a message outbox, and the like.

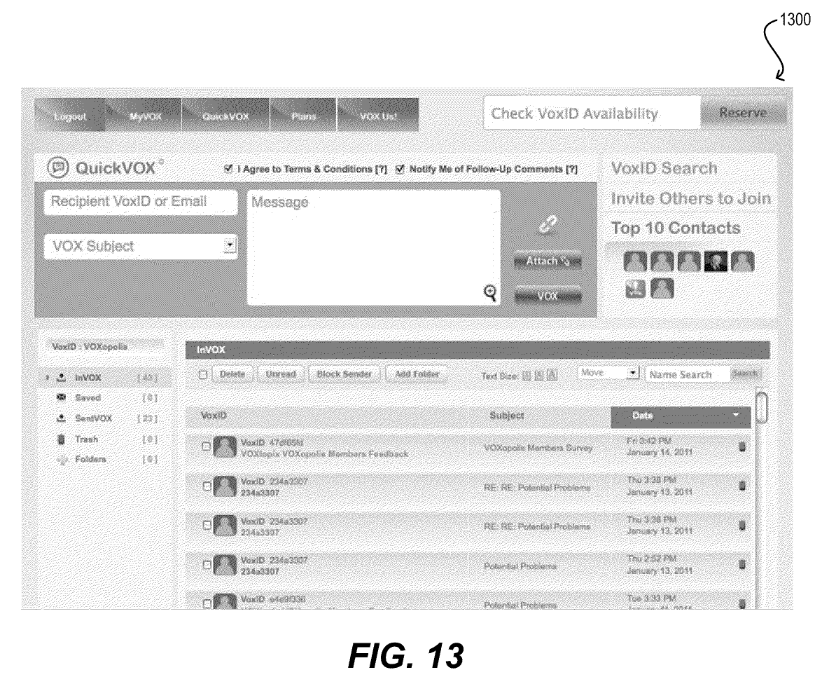

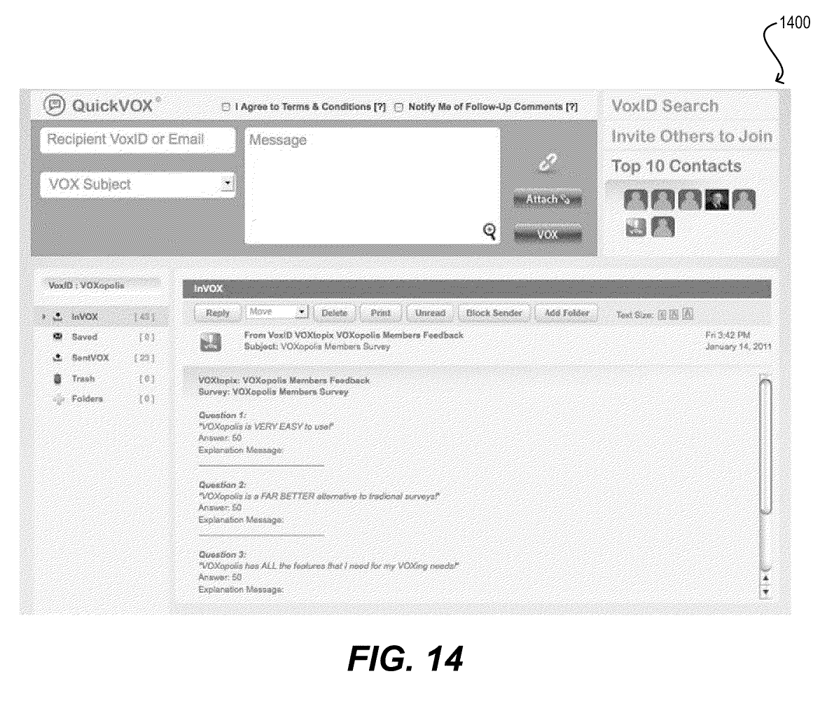

At block 432, the administrator can access his/her message inbox and view the message comprising the survey/poll responses submitted by the respondent. FIGS. 13 and 14 illustrate user interfaces that show an exemplary view of the message inbox and a exemplary view of a received message (1300 and 1400 respectively). As can be seen in interface 1300, the message displayed to the administrator only identifies the anonymous identifier of the respondent; the message does not include any other information that may reveal the identity of the respondent.

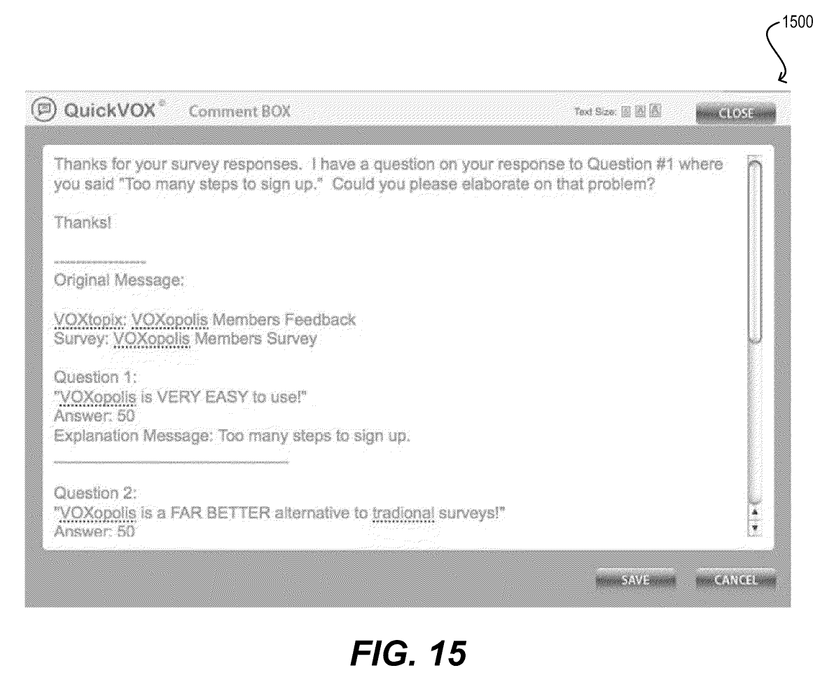

After the administrator has viewed the received message, the administrator can activate a user interface control for replying to the message (see the “reply” button in interface 1400) (block 434). In response, anonymous interactive communication system 114 can generate a message composition user interface (see interface 1500 of FIG. 15) (block 436). In one set of embodiments, the message composition user interface can be pre-populated such that the “recipient” field is the anonymous identifier of respondent. The interface can also include the content of the original message received from the respondent for quotation purposes.

At block 438, the administrator can enter his/her reply message via the message composition user interface, which is captured by system 114 and stored for later retrieval by the respondent (block 440). In various embodiments, the stored message is addressed from the non-anonymous identifier of the administrator and addressed to the anonymous identifier of the respondent. System 114 can subsequently send a delivery notification via email (or other means) to the respondent to notify the respondent that a new message has been received (block 442).

In this manner, the survey/polling administrator and the survey/polling respondent can engage in a two-way dialogue via anonymous interactive communication system 114. For example, although not shown, the respondent can send a response to the reply message of the administrator, and this interactive communication can continue in perpetuity until one of the parties breaks off communication. Throughout this process, the true identity of the respondent can remain hidden from the administrator.

Although specific embodiments of the present invention are described above, it should be appreciated that various modifications, alterations, alternative constructions, and equivalents are within the scope of the invention. For instance, although process 400 indicates that the respondent must login/register to anonymous interactive communication system 114 prior to completing the survey or poll, in certain embodiments the respondent can enter his/her responses and then provide login/registration details upon the act of submitting the responses, rather than before.

As another example, although certain embodiments are described as enabling anonymous interactive communication between a single survey/polling administrator and a single survey/polling respondent, the techniques described herein can be used to enable anonymous interactive communication between any number of parties. For instance, the survey/poll responses submitted by a particular respondent can be send to a group of survey/polling administrators or managers, and any of the recipients can reply to everyone while maintaining the anonymity of the respondent.

Further, although certain embodiments are described with respect to certain flow diagrams and steps, it should be apparent to those skilled in the art that the scope of the present invention is not limited to the described diagrams/steps.

Yet further, although certain embodiments are described using a particular combination of hardware and software, it should be recognized that other combinations of hardware and software are also within the scope of the present invention.

The specification and drawings are, accordingly, to be regarded in a illustrative rather than restrictive sense. It will be evident that additions, subtractions, and other modifications can be made thereunto without departing from the broader spirit and scope of the invention as set forth in the following claims.

What is claimed is:

1. A method comprising:
receiving, by a computer system from a respondent, one or more responses to a survey or poll;
communicating, by the computer system, the one or more responses to an administrator of the survey or poll, wherein the identity of the respondent is kept anonymous; and
enabling, by the computer system, the administrator to interactively communicate with the respondent regarding the one or more responses while keeping the identity of the respondent anonymous.

2. The method of claim 1 further comprising, prior to receiving the one or more responses:
generating a sign-in user interface requesting a non-anonymous identifier from the respondent;
receiving, from the respondent, the non-anonymous identifier; and
generating account information for the respondent, the account information including the non-anonymous identifier and an anonymous identifier.

3. The method of claim 2 further comprising, upon receiving the one or more responses:
associating the one or more responses with the account information generated for the respondent.

4. The method of claim 2 wherein the non-anonymous identifier is an e-mail address.

5. The method of claim 2 wherein the anonymous identifier is a randomly-generated string.

6. The method of claim 1 further comprising, prior to receiving the one or more responses:
generating a sign-in user interface requesting a non-anonymous identifier and authentication information from the respondent;
receiving, from the respondent, the non-anonymous identifier and the authentication information; and
authenticating the respondent based on the non-anonymous identifier and the authentication information, the authenticating including accessing account information previously generated for the respondent.

7. The method of claim 6 further comprising, upon receiving the one or more responses:
associating the one or more responses with the account information previously generated for the respondent.

8. The method of claim 6 wherein the non-anonymous identifier is an e-mail address.

9. The method of claim 6 wherein the authentication information is an account password.

10. The method of claim 1 wherein communicating the one or more responses to the administrator comprises transmitting an e-mail including the one or more responses to the administrator.

11. The method of claim 1 wherein communicating the one or more responses to the administrator comprises generating a user interface for presenting the one or more responses to the administrator, the one more responses being identified in the user interface as being sent from an anonymous identifier.

12. The method of claim 11 wherein enabling the administrator to interactively communicate with the respondent regarding the one or more responses while keeping the identity of the respondent anonymous comprises:
receiving a message from the administrator addressed to the anonymous identifier;
communicating the message to the respondent; and
enabling the respondent to respond to the message.

13. The method of claim 12 wherein communicating the message to the respondent comprises:
determining, based on the anonymous identifier, an e-mail address of the respondent; and
transmitting an e-mail to the e-mail address notifying the respondent that the message has been sent.

14. The method of claim 1 wherein the one or more responses include qualitative responses.

15. The method of claim 1 wherein the one or more responses include quantitative responses.

16. A computer-readable storage medium having stored thereon program code executable by a processor, the program code comprising:
code that causes the processor to receive one or more responses to a survey or poll;
code that causes the processor to communicate the one or more responses to an administrator of the survey or poll, wherein the identity of the respondent is kept anonymous; and
code that causes the processor to enable the administrator to interactively communicate with the respondent regarding the one or more responses while keeping the identity of the respondent anonymous.

17. The computer-readable storage medium of claim 16 wherein the code that causes the processor to communicate the one or more responses to the administrator comprises code that causes the processor to generate a user interface for presenting the one or more responses to the administrator, the one more responses being identified in the user interface as being sent from an anonymous identifier.

18. The computer-readable storage medium of claim 17 wherein the code that causes the processor to enable the administrator to interactively communicate with the respondent regarding the one or more responses while keeping the identity of the respondent anonymous comprises:
code that causes the processor to receive a message from the administrator addressed to the anonymous identifier;
code that causes the processor to communicate the message to the respondent; and
code that causes the processor to enable the respondent to respond to the message.

19. A system comprising:
a processor configured to:
receive, from a respondent, one or more responses to a survey or poll;
communicate the one or more responses to an administrator of the survey or poll, wherein the identity of the respondent is kept anonymous; and
enable the administrator to interactively communicate with the respondent regarding the one or more responses while keeping the identity of the respondent anonymous.

20. The system of claim 19 wherein communicating the one or more responses to the administrator comprises generating a user interface for presenting the one or more responses to the administrator, the one more responses being identified in the user interface as being sent from an anonymous identifier.

21. The system of claim 20 wherein enabling the administrator to interactively communicate with the respondent regarding the one or more responses while keeping the identity of the respondent anonymous comprises:
receiving a message from the administrator addressed to the anonymous identifier;
communicating the message to the respondent; and
enabling the respondent to respond to the message.
